(19) United States
(12) Patent Application Publication
(10) Pub. No.: US 2004/0183648 A1
(43) Pub. Date: Sep. 23, 2004

(54) Strain sensors and housings and circuit boards with integrated strain sensors

(76) Inventors: Thomas E. Weber, Lisle, IL (US); William L. Olson, Lake Villa, IL (US); Andrew F. Skipor, West Chicago, IL (US)

Correspondence Address: MOTOROLA, INC., 1303 EAST ALGONQUIN ROAD, IL01/3RD, SCHAUMBURG, IL, 60196

(21) Appl. No.: 10/394,622

(22) Filed: Mar. 21, 2003

(51) Int. Cl. G01L 1/22; H01C 10/10

(52) U.S. Cl. 338/47

(57) ABSTRACT

Mechanical testing prototype housings (102) and circuit boards (204, 206) are provided with strain sensors (110, 218, 810) that include piezoresistive material (306, 516, 808) the resistance of which changes in response to strain. The housings and circuit boards are useful for stress testing to evaluate the mechanical robustness of particular housing designs, and circuit board layouts. Circuit boards including the strain sensors can be used to evaluate candidate locations for placement of electrical test contact probe areas (524, 526, 602).

### FIELD OF THE INVENTION

The present invention relates to strain sensors and apparatus incorporating strain sensors.

### BACKGROUND OF THE INVENTION

As the field of electronics continues to develop at a rapid pace, increasingly complex and sophisticated electronic circuit boards and assemblies are being manufactured. Presently, circuit boards that have high density interconnect layers that interconnects complex components having high density pin arrangements are used. The probability of defects is increased by number of interconnections, and the density of the interconnections. In order to maintain the quality standards, it is desirable to test circuit boards at the conclusion of manufacturing processes. One type of apparatus for testing circuit boards is the so called bed of nails tester. In the bed of nails testers, a plurality of pins are urged against electrical test point contact pads on one or both sides of the circuit board under test. The pins allow test signals to be applied to the circuit board and/or signals produced by the board to be coupled out, in order to verify the correct operation of the board. Unfortunately, the pins exert localized stresses on the circuit board under test that can damage solder joint connections. Given the high density of components on circuit boards, especially those for sophisticated portable devices, it is not always easy to find space for test point contact pads. Some of the candidate locations for test point contact pads may be undesirable, because the stress associated with a bed of nails tester pin applied at such locations could lead to solder joint or other failure of circuit boards. Test pins applied to both sides of a board, which in general are not aligned, set up complex stress fields in the circuit boards being tested. It would be desirable to be able to evaluate the stresses produced by test probes in a given arrangement in order to ascertain if the arrangement might lead to potentially damaging stress at certain locations, e.g., the locations of critical solder joints.

Another type of stress to which circuit boards are subject in the course of the manufacturing processes is the stress that occurs when a portion that is used to hold the circuit board at various stages of the manufacturing process is broken off. It would be desirable to be able to ascertain the stress caused at various points in the board e.g., at the location of critical solder joints, by breaking of the portion. In general it would be desirable to be able to evaluate the stresses occurring, in circuit board during manufacturing.

Beyond the manufacturing process, circuit boards, and housings of portable electronic apparatus undergo stresses in use. For example, time to time dropping of portable electronic apparatus is inevitable and should be accounted for in the design of such apparatus. It would be desirable to be able to evaluate the stress generated in portable electronic devices in response to various externally applied stresses such as dropping.

### BRIEF DESCRIPTION OF THE FIGURES

The present invention will be described by way of exemplary embodiments, but not limitations, illustrated in the accompanying drawings in which like references denote similar elements, and in which:

FIG. 1 is a front view of a mechanical testing prototype of a wireless communication device according to the preferred embodiment of the invention;

FIG. 2 is a cross sectional side view of the mechanical testing prototype shown in FIG. 1;

FIG. 3 is a magnified view of a portion of a housing of the mechanical testing prototype shown in FIG. 1 including a strain sensor;

FIG. 4 is a cross sectional view of the portion of the housing shown in FIG. 3;

FIG. 5 is a magnified view of a portion of a circuit board of the mechanical testing prototype that is shown in FIG. 2;

FIG. 6 is a plan view of the circuit board of the mechanical testing prototype that is shown in FIG. 2;

FIG. 7 is a bed of nails type circuit board tester engaging a circuit board under test;

FIG. 8 is a magnified view of a portion of the housing of the mechanical testing prototype shown in FIGS. 1-2 including a strain sensor according to an alternative embodiment of the invention;

FIG. 9 is cross sectional view of the portion of the housing shown in FIG. 8 including the strain sensor according to the alternative embodiment of the invention;

FIG. 10 is flow chart of a method of fabricating the strain sensor shown in FIGS. 3-4;

FIG. 11 is a flow chart of a method of fabricating the strain sensor shown in FIG. 5;

FIG. 12 is a plot demonstrating the correlation between a prototype strain sensor similar to that shown in FIG. 5, and a commercial off the shelf strain sensor; and

FIG. 13 is a flow chart of a method of evaluating candidate locations for test probe pads according to an embodiment of the invention.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

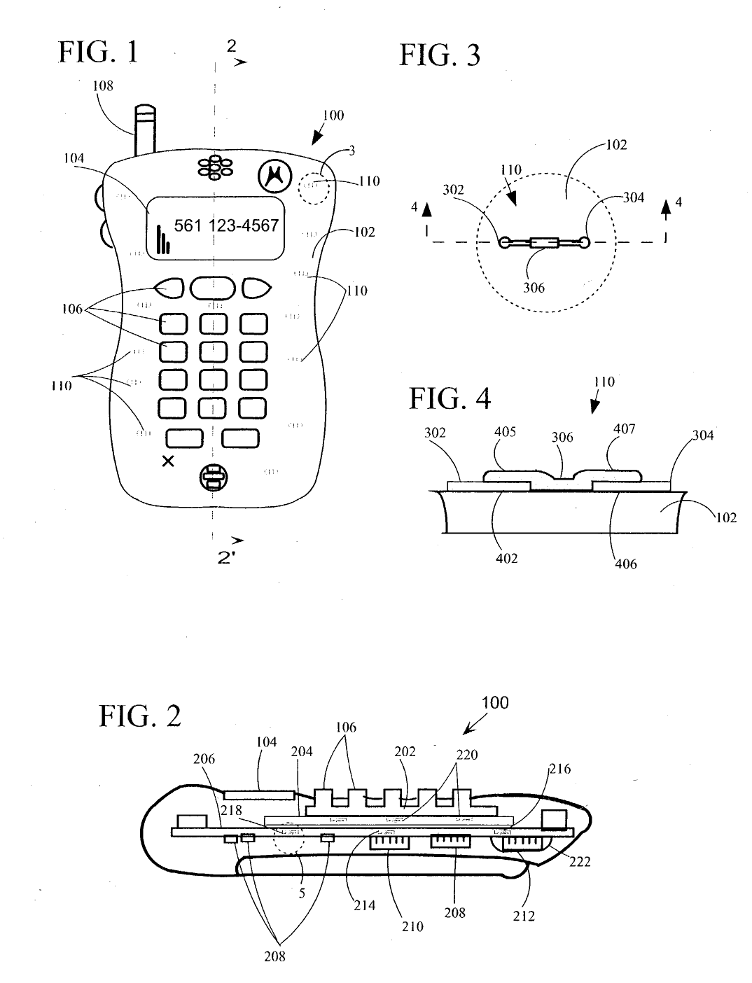

FIG. 1 is a front view of a mechanical testing prototype of a wireless communication device 100 according to the preferred embodiment of the invention and FIG. 2 is a cross sectional side view of the mechanical testing prototype 100. The device 100 comprises a housing 102 which is preferably made of molded plastic. The housing 102 supports a number of components of the device 100, including a display 104, a keypad 202 that includes a plurality of keys 106, and an antenna 108. The housing 102 encloses a number of components including a first circuit board 204 that includes metallization traces that are selectively connected by the plurality of keys, and a second circuit board 206 that supports and interconnects a plurality of circuit elements 208, 210, 212 (e.g., integrated circuits, resistors, capacitors, crystals) that comprise communication circuits, including a surface mount integrated circuit 210, and an integrated circuit 212. A plurality of strain sensors 214, 216, 218, 220 are included in the first 204, and second 206 circuit boards. A first strain sensor 214 is located under the surface mount integrated circuit 210. A second strain sensor 216 is located under an EMI/RFI component shield 222 that covers the integrated circuit 212.

A plurality of strain sensors 110 are supported on the housing. In use, wires (not shown) are attached to the strain sensors 110 in order to couple signals from the strain sensors 110. Wires can be attached using conductive adhesive. The strain sensors 110 are used to measure strain in the housing 102, when the housing is subjected to stresses during testing. For example, one type of stress test, in which the strain sensors 110 can be used is drop testing. Although the wireless communication device 100 is depicted in FIGS. 1-2, the invention is alternatively applied to other types of devices.

FIG. 3 is a magnified view of a portion of a housing 102 of the mechanical testing prototype 100 shown in FIG. 1 that includes one of the strain sensors 110. FIG. 4 is a cross sectional view of the portion of the housing 102 shown in FIG. 3. Each strain sensor 110 comprises a first contact terminal 302, and a second contact terminal 304 formed on the housing 102. The first contact terminal 302 is spaced from the second contact terminal 304. The first contact terminal 302 and the second contact terminal 304 preferably comprise a conductive compound, such as a silver particle filled resin. The first contact terminal 302 and the second contact terminal 304 are preferably formed on the housing 102 by screen printing. An example of a material that can be used to form the first and second contact terminals 302, 304 is LS-411AW manufactured by Asahi Chemical Research Laboratory Co, and distributed by Advanced PCB Products, LLC of Prosper, Tex.

A body of piezoresisitive material 306 comprises a first end 405 that overlaps a portion 402 of the first contact terminal 302 proximate the second contact terminal 304, and a second end 407 that overlaps a portion 406 of the second contact terminal 304 proximate the first contact terminal 402. The piezoresistive material 306 functions as a piezoresistive resistor. The piezoresistive material 306 extends between the first contact terminal 302, and the second contact terminal 304. The ends 405, 407 of the piezoresistive material 306 are conductively coupled to the terminals 302, 304.

In response to strain of the housing 102, the resistance of the piezoresisitive material 306 changes and the changes can be measured, and used as indication of the strain of the housing 102.

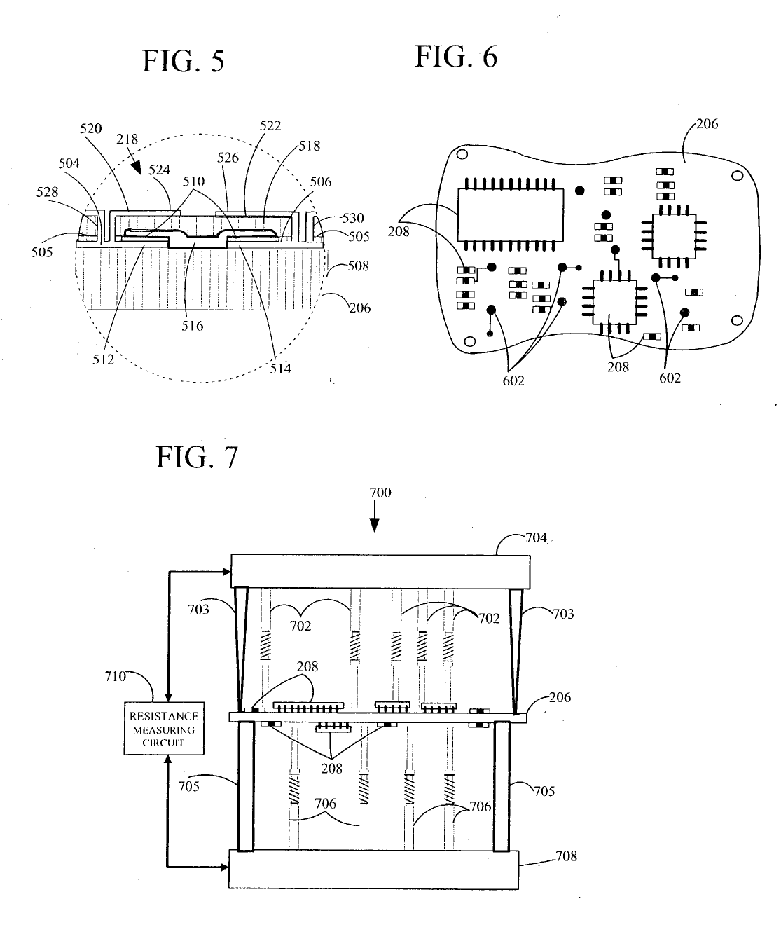

FIG. 5 is a magnified view of a portion of the second circuit board 206 of the mechanical testing prototype 100. The magnified view shown in FIG. 5, shows the strain sensor 218 that is integrated into the second circuit board 206. The first circuit board 204, and the second circuit board 206 preferably comprise a plurality of strain sensors of the type shown in FIG. 5. Strain sensors of the type shown in FIG. 5, incorporated into the first circuit board 204 are advantageously used to measure the stresses induced in the first circuit board when the keys 106 are actuated with different magnitude forces. Strain sensors of the type shown in FIG. 5 incorporated into the second circuit board 206 are advantageously used to measure stresses that occur in the second circuit board 206 when the mechanical testing prototype 100 is subjected to stress testing such as drop testing or when evaluating stress induced by breaking off a portion of the circuit board. Additionally, the strain sensors of the type shown in FIG. 5, incorporated into a circuit board (e.g., 204, 206) are preferably used to measure strains that occur in the circuit board (e.g., 204, 206) when the circuit board (e.g. 204, 206) is tested in a “Bed of Nails” type tester. The latter application is more fully described below with reference to FIGS. 6-7.

The strain sensor 218, shown in FIG. 5 comprises a first copper contact terminal 504, and a second contact terminal 506 supported in spaced relation on a substrate 508 of the second circuit board 206. The first and second contact terminals, 504, 506 need not be supported directly on a main substrate, rather the contact terminals 504, 506 can be supported on any interlayer dielectric layer of a multilayer circuit board. A plating mask 505 is formed over the first and second contact terminals 504, 506. The plating mask 505 preferably comprises a photo dielectric. An ohmic contact enhancing material 510 is applied to, at least, a portion 512 of the first contact terminal 504 proximate the second contact terminal 506, and on a portion 514 of the second contact terminal 506 proximate the first contact terminal 504. The ohmic contact enhancing material 510 preferably comprises silver that is selectively electroplated onto the first and second contact terminals using the plating mask 505 to control the geometry of the areas on which the silver is plated. Alternatively, the contact enhancing material 510 is not used.

A piezoresisitive material 516 overlaps the ohmic contact enhancing material 510 on the first and second contact terminals 504, 506, and extends between the first and second contact terminals 504, 506. Between the contact terminals 504, 506, the piezoresistive material 516 is supported on the substrate 508. Alternatively, the piezoresistive material is supported on plating mask material 505 between the contact terminals 504, 506. The piezoresistive material 516 preferably comprises conductive particles in a resin matrix e.g., a conductive particle filled polymer. More preferably, the piezoresisitive material 516 comprises carbon particles in a resin matrix. The piezoresistive material 516 is preferably screen printable, and is preferably applied by screen printing. One example of a piezoresistive material that is suitable for use in the present invention is that sold under the trade designation TU-00-8 series by Asahi Chemical Research Laboratory of Tokyo, Japan.

An interlayer dielectric 518 is positioned over (in the perspective of FIG. 5) the first contact terminal 504, the second contact terminal 506, and the piezoresisitive material 516, such that the contact terminals 504, 506, and the piezoresisitive material 516 is between the substrate 508, and the interlayer dielectric 518. A first metallization trace 520, and a second metallization trace 522 are located on top of the interlayer dielectric 518. The traces 520, 522 are located on a side of the interlayer dielectric opposite from the contact terminals 504, 506, and the piezoresistive material 516. The first trace 520 passes over the first contact terminal 504, and the second trace 522 passes over the second contact terminal 506. The first trace 520 is coupled to a first test probe pad 524, and the second trace 522 is coupled to a second test probe pad 526. Although not apparent in FIG. 5 the first and second pads 524, 526 are preferably enlarged relative to the traces 520, 522 to facilitate alignment and electrical contacting of external electrical test probes. A first via 528 extends from the first trace 520 through the interlayer dielectric 518 and the plating mask 505 to the first electrical contact 512. Similarly, a second via 530 extends from the second trace 522 through the interlayer dielectric 518 and the plating mask 505 to the second electrical contact 514.

In operation, electrical test probes are contacted with the pads 524, 526 in order to measure the resistance of the piezoresistive material 516, while mechanical stresses are applied to the second circuit board 206, e.g., by electrical test probes bearing against the pads 524, 526. The resistance of the piezoresisitive material 516 changes in response to strain induced by the stresses. The measured resistance is indicative of the strain of the second circuit board 206 or other circuit boards in which one or more strain sensors are incorporated.

FIG. 6 is a plan view of the second circuit board 206 of the mechanical testing prototype that is shown in FIG. 2. The circuit board 206 is a mechanical testing prototype. Different variations of the circuit board 206 can be made for different uses. One use of the circuit board 206 is within the mechanical testing prototype of a wireless communication device 100, for stress testing such as drop testing. A second use is to evaluate the strain induced in the circuit board 206 by a bed of nails type electrical tester. The circuit board 206 is preferably a modification of a production circuit board in which a plurality of strain sensors of the type shown in FIG. 5 are incorporated, and a plurality of test probe pads 602 are connected (e.g., through metallization traces, and vias) to strain sensors, rather than being connected to communication (or other) circuit elements 208 as would be the case in a production circuit board. In the modified second circuit board 206 used for testing the strain induced by test probes, the test probe pads 602 are preferably located in the same positions as test probe pads are to be located in a production circuit board, so that the strains induced in the second circuit board when placed in a bed of nails tester will be equivalent to what is induced in testing a production board. The strain sensors are preferably located near strain sensitive points, e.g., near the location of solder joints. Advantageously, strain sensors of the type shown in FIG. 5 can be located in positions where it would be problematic to locate conventional strain sensors. Examples of such locations are underneath surface mount components, underneath solder joints (at a subsurface layer) and underneath component shields.

By providing the strain sensors of the type shown in FIG. 5 in the mechanical testing prototype of the second circuit board 206, candidate locations for test probe pads can be evaluated to ascertain if application of stress by electrical test probes at the candidate locations leads to excessive strain in the circuit board 206. If it is found that excessive strain is caused by a test probe pressing a contact area at a particular candidate location, another location can be chosen for the contact area. Accordingly, the mechanical testing prototype circuit board 206, facilitates selecting locations for test probe pads in a production board that lead to a reduction of the mechanical strain at critical locations induced in a board by electrical contact probes. Reducing strain reduces the number of solder connection failures caused by mechanical stress associated with electrical testing, and improves circuit board production yield. Although the second circuit board 206 of the wireless device circuit board 100 is depicted in FIG. 6, it is to be understood that the invention is alternatively applied to other types of circuit boards.

FIG. 7 is a bed of nails type circuit board tester 700 engaging the second circuit board 206 during testing. The tester 700 comprises an upper set of spring biased electrical contact probes 702 supported by an upper support 704, and a lower set of spring biased electrical contact probes 706 supported by a lower support 708. The electrical contact probes 702, 706 engage test probe pads (e.g., 524, 526, 602) on opposite sides of the testing prototype circuit board 206. The electrical contact probes 702, 706 must engage the test probe pads (e.g., 524, 526, 602) with sufficient pressure to make good electrical contact. A plurality of conical push fingers 703, supported by the upper support 704, and a plurality cylindrical push stops 705 supported by the lower support 708 also engage the circuit board 206 during testing. In engaging the test probe pads (e.g., 524, 526, 602) the test probes 702, 706 induce mechanical strains, which if the locations of the probe pads (e.g., 524, 526, 602) are not well chosen can lead to high strains induced in the circuit board, (and a corresponding production board), and increase failures due to solder connection failures. The push fingers 703, and push stops 705, limit the strain exerted by the electrical contact probes 702, 706, but also induce strain themselves. Because of the density of components on modem circuit boards, particularly those for high functionality portable devices the choice of locations for test probe pads is somewhat constrained, leading in some instances to placement of test pads near solder joints. In general and in the latter case in particular it is desirable to be able to evaluate the strain induced by electrical contact probes engaging test probe pads in particular locations, and the push fingers 703, and push stops 705 engaging the circuit board 206 under test in particular locations.

Inclusion of strain sensors of the type shown in FIG. 5 in the testing prototype second circuit board 206 allows different candidate locations to be evaluated. To evaluate candidate locations, a prototype board that includes test probe pads at the candidate locations, and includes strain sensors of the type shown in FIG. 5 coupled between the test probe pads is fabricated. A resistance measuring circuit 710 that is electrically coupled to the contact probes 706 is used to measure the resistance of the piezoresistive material 516 in the strain sensors 214-220 as an indication of strain. Note that in testing production boards the resistance measuring circuit is replaced with a test circuit used to test electrical circuits of production boards (e.g., communication circuits).

Strain sensors of the type shown in FIG. 5, that are included in circuit boards are also useful in evaluating the stresses that occur in circuit boards that are subjected to manufacturing operations aside from bed-of-nails testing. For example strain that occurs during the depanelization, or assembly are alternatively evaluated using strain sensors of the type shown in FIG. 5. For testing other than bed-of-nails testing, wires are alternatively conductively coupled (e.g., by soldering) to the test probe pads (e.g., 524, 526, 602).

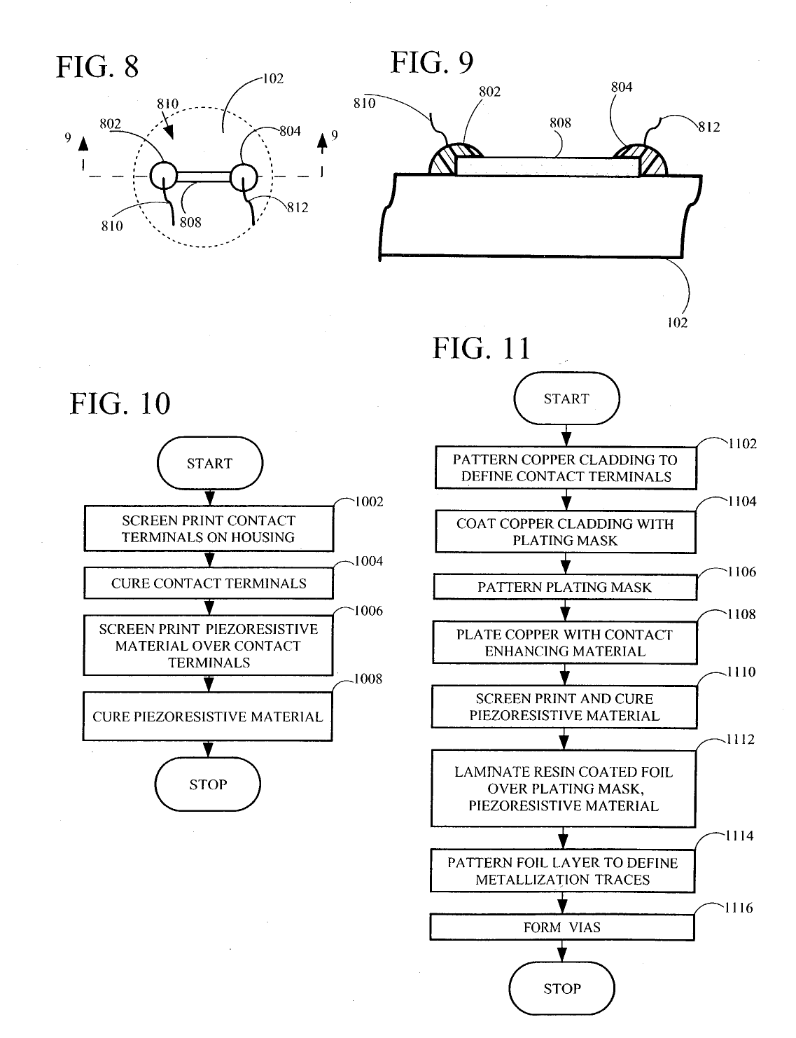

FIG. 8 is a magnified view of a portion of the housing 102 of the mechanical testing prototype 100 shown in FIGS. 1-2 including a strain sensor 810 according to an alternative embodiment of the invention, and FIG. 10 is cross sectional view of the portion of the housing shown in FIG. 8. The alternative strain sensor 810 comprises a strip of piezoresisitive material 808 that is formed on the housing 802, preferably by screen printing. The piezoresisitive material preferably comprises carbon particles in a resin matrix. A first mass of conductive adhesive 802 is disposed at the first end of the strip of piezoresistive material 808, and second mass of conductive adhesive 804 is disposed at a second end of the strip of piezoresistive material 808. A first wire 810 is embedded in the first mass of conductive adhesive 802, and a second wire 812 is embedded in the second mass of conductive adhesive 804. The wires 810, 812 are used to couple the strain sensor 810 to an external resistance measuring circuit.

FIG. 10 is flow chart of a method of fabricating the strain sensor 110 shown in detail in FIGS. 3-4. In step 1002 the contact terminals 302, 304 are screen printed on the housing 102. The contact terminals 302, 304 preferably comprise a screen printable, curable (e.g., thermally and/or ultraviolet curable) silver filled resin. In step 1004 the contact terminals are cured. In step 1006 the piezoresistive material 306 is screen printed over the contact terminals 302, 304. The piezoresistive material 306 preferably comprises a curable carbon filled polymer. In step 1008 the piezoresistive material 306 is cured.

FIG. 11 is a flow chart of a method of fabricating the strain sensor 218 shown in detail in FIG. 5. In step 1102, a copper layer of a copper clad printed circuit board substrate is patterned to define the contact terminals 512, 514. In step 1104 the patterned copper layer is coated with a plating mask material. In step 1106 the plating mask material is patterned. In step 1108 the patterned plating mask material is used to selectively deposit the ohmic contact enhancing material 510 (e.g., silver). In step 1110 the piezoresistive material 516 is screen printed and cured. In step 1112 a resin coated foil which comprises the interlayer dielectric 518, and a foil layer out of which the first and second metallization traces 520, 522 are to be formed is laminated over the plating mask 505, and piezoresistive material 516. In step 1114 the foil of the resin coated foil is patterned to define the metallization traces 520, 522, and in step 1116 the vias 528, 530 are formed.

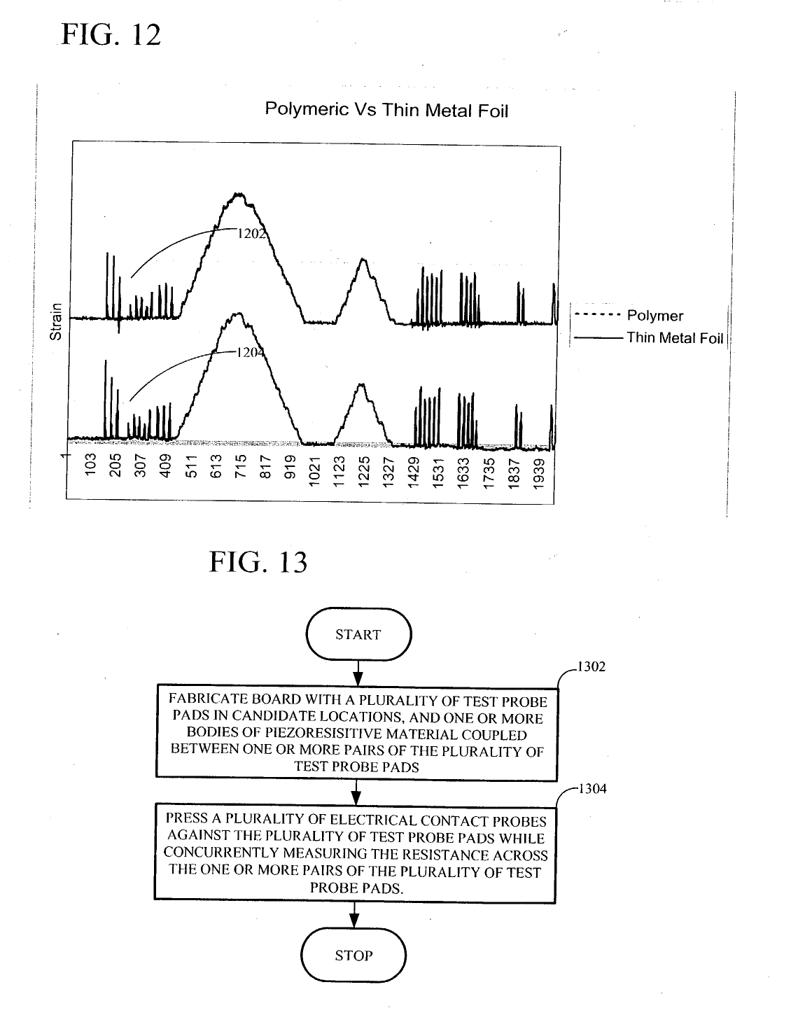

FIG. 12 is a graph demonstrating the correlation between a prototype strain sensor similar to that shown in FIG. 5, and a commercial off the shelf strain sensor. An upper plot 1202 reflects the resistance changes of a strain sensor which includes a screen printed carbon filled polymer piezoresistive materials and is similar to that shown in FIG. 5 in response to applied stresses. The lower plot 1204 reflects the resistance changes of a commercial off the shelf strain sensors in response to same applied stresses. The commercial off the shelf strain sensor a model 125AD strain sensor sold by Malvern, Pa. The graph demonstrates that strain sensors as described above which can, among other things, be integrated into circuit boards for evaluating candidate locations for test probe contact areas, and formed on plastic housing parts. for stress testing and will perform in similar fashion to discrete component strain sensors.

FIG. 13 is a flow chart of a method of evaluating candidate locations for test probe pads according to an embodiment of the invention. In step 1302 a circuit board that comprises a plurality of test probe pads at candidate locations, and one or more bodies (e.g., strips) of piezoresistive material coupled between one or more pairs of the plurality of test probe pads is fabricated. In step 1304 a plurality of electrical contact probes are pressed against the plurality of test probe pads while concurrently measuring the resistance across the one or more pairs of the plurality of test probe pads in order to measure the strain induced in the circuit board by pressing the electrical contact probes at the candidate locations.

While the preferred and other embodiments of the invention have been illustrated and described, it will be clear that the invention is not so limited. Numerous modifications, changes, variations, substitutions, and equivalents will occur to those of ordinary skill in the art without departing from the spirit and scope of the present invention as defined by the following claims.

What is claimed is:

1. A circuit board with integrated strain sensor comprising:
a first contact adapted for coupling to an external resistance measuring circuit;
a second contact adapted for coupling to the external resistance measure circuit, said second contact disposed in spaced relation to the first contact;
a piezoresistive material extending between the first contact and the second contact;
whereby, flexing of the circuit board causes a change of resistance in the piezoresistive material that can be used to sense strain of the circuit board.

2. The circuit board with integrated stain sensor according to claim 1 wherein:
the piezoresistive material comprises a conductive particle filled polymer.

3. The circuit board with integrated strain sensor according to claim 2 wherein:
the piezoresistive material comprises a carbon particle filled polymer.

4. The circuit board with integrated strain sensor according to claim 1 wherein:
the piezoresistive material is deposited by screen printing.

5. The circuit board with integrated strain sensor according to claim 1 further comprising:
a first test probe pad coupled to first contact; and
a second test probe pad coupled to the second contact.

6. A circuit board for evaluating the strain induced by application of electrical probes to test probe pads at particular locations, the circuit board comprising:
a first test probe pad;
a second test probe pad; and
a piezoresistive material coupled to the first test probe pad and the second test probe pad.

7. The circuit board according to claim 6 further comprising:
a surface mount component;
wherein the piezoresistive material is located under the surface mount component.

8. The circuit board according to claim 7 further comprising:
a component shield;
wherein, the piezoresistive material is located under the component shield.

9. A method of evaluating potential locations for test probe pads on a circuit comprising:
fabricating a circuit board that comprises:
a plurality of test probe pads at candidate locations;
one or more bodies of piezoresistive material coupled between one or more pairs of the plurality of test probe pads; and
pressing a plurality of electrical contact probes against the plurality of test probe pads while concurrently measuring the resistance across the one or more pairs of the plurality of test probe pads.

10. A plastic housing with integrated strain sensor comprising:
a first terminal supported on said plastic housing;
a second terminal supported on said plastic housing in spaced relation to the first terminal; and
a printed piezoresistive resistor formed on the plastic housing, said printed piezoresistive resistor having a first end conductively coupled to the first terminal, and a second end conductively coupled to the second terminal.

11. The plastic housing with integrated strain sensor according to claim 10 wherein:
the first terminal comprises a screen printed conductive particle filled resin;
the second terminal comprises a screen printed conductive particle filled resin;
the first end of the piezoresistive resistor overlies the first terminal; and
the second end of the piezoresistive resistor overlies the second terminal.

12. A prototype portable electronic device comprising:
a plurality of strain sensors, each comprising:
a first terminal;
a second terminal;
a screen printed piezoresistive resistor extending between the first terminal and the second terminal.
